(19) United States
(12) Patent Application Publication
(10) Pub. No.: US 2025/0272892 A1
(43) Pub. Date: Aug. 28, 2025

(54) LEARNING APPARATUS, CONVERTING APPARATUS, METHODS AND PROGRAMS

(71) Applicant: NIPPON TELEGRAPH AND TELEPHONE CORPORATION, Tokyo (JP)

(72) Inventors: Daisuke NIIZUMI, Tokyo (JP); Kunio KASHINO, Tokyo (JP); Yasunori OHISHI, Tokyo (JP); Daiki TAKEUCHI, Tokyo (JP); Noboru HARADA, Tokyo (JP)

(73) Assignee: NIPPON TELEGRAPH AND TELEPHONE CORPORATION, Tokyo (JP)

(21) Appl. No.: 18/858,453

(22) PCT Filed: Apr. 25, 2022
(86) PCT No.: PCT/JP2022/018702

§ 371 Date: Oct. 21, 2024

(51) Int. Cl. G06T 11/20; G10L 21/12; G10L 21/18; G10L 25/18

(52) U.S. Cl. CPC G06T 11/206; G10L 21/12; G10L 21/18; G10L 25/18

(57) ABSTRACT

A learning device includes: spectrogram generation circuitry 1 that generates a spectrogram from a first sound signal and generates a target spectrogram from a second sound signal; patch generation circuitry 2 that divides the spectrogram to generate a plurality of patches and divides the target spectrogram to generate a plurality of target patches; mask processing circuitry 3 that selects some patches as masked patches; reconstruction circuitry 4 that obtains a plurality of reconstructed patches by reconstructing the plurality of patches by processing of an encoder and a decoder by using visible patches other than some patches among the plurality of patches and mask tokens; and parameter update circuitry 5 that updates parameters such that target patches corresponding to the masked patches among the plurality of target patches approach reconstructed patches corresponding to the masked patches among the plurality of reconstructed patches.

### TECHNICAL FIELD

The present invention relates to a deep learning technique.

### BACKGROUND ART

In fields other than sounds in particular, there are frameworks for expression learning called Masked Language Modeling (MLM) and Masked Image Modeling (MIM). Those frameworks mask part of an input and use information obtained from a non-masked portion to restore and predict the masked portion. The frameworks aim to obtain a good information extraction model (also referred to as an encoder, and also abstractly referred to as an “expression”) by performing learning so as to extract effective information from the non-masked portion.

Regarding sound signals, Non Patent Literature 1 proposes learning in which mask restoration and classification are combined with respect to a spectrogram.

### CITATION LIST

### Non Patent Literature

Non Patent Literature 1: Yuan Gong, Cheng-I Jeff Lai, Yu-An Chung, James Glass, “SSAST: Self-Supervised Audio Spectrogram Transformer”, MIT Computer Science and Artificial Intelligence Laboratory, Cambridge, MA 02139

### SUMMARY OF INVENTION

### Technical Problem

The technique of Non Patent Literature 1 cannot be used to solve general tasks such as noise removal, super-resolution, style transfer, and anomaly detection.

An object of the present invention is to provide a learning device that learns a model usable for solving general tasks, and a transform device, method, and program capable of solving general tasks.

### Solution to Problem

A learning device according to an aspect of the present invention includes: a spectrogram generation unit that generates a spectrogram from an input first sound signal and generates a target spectrogram from an input second sound signal; a patch generation unit that divides the generated spectrogram to generate a plurality of patches and divides the generated target spectrogram to generate a plurality of target patches; a mask processing unit that selects some patches from among the plurality of patches as masked patches; a reconstruction unit that obtains a plurality of reconstructed patches by reconstructing the plurality of patches by processing of an encoder and a decoder in a transformer serving as a deep learning model by using visible patches other than the some patches among the plurality of patches and mask tokens corresponding to the masked patches; and a parameter update unit that updates a parameter of the encoder and a parameter of the decoder such that target patches corresponding to the masked patches among the plurality of target patches approach reconstructed patches corresponding to the masked patches among the plurality of reconstructed patches.

A transform device according to an aspect of the present invention includes: a storage unit that stores the encoder and the decoder learned by the learning device; a spectrogram generation unit that generates a spectrogram from an input sound signal; a patch generation unit that divides the generated spectrogram to generate a plurality of patches; a mask processing unit that selects some patches from among the plurality of patches as masked patches; and a reconstruction unit that obtains a plurality of reconstructed patches by reconstructing the plurality of patches by processing of the encoder and the decoder read from the storage unit by using visible patches other than the some patches among the plurality of patches and mask tokens corresponding to the masked patches.

### Advantageous Effects of Invention

It is possible to learn a model usable for solving general tasks. Alternatively, it is possible to solve general tasks.

### BRIEF DESCRIPTION OF DRAWINGS

FIG. 1 shows an example of a functional configuration of a learning device.

FIG. 2 shows an example of a processing procedure of a learning method.

FIG. 3 shows an overview of a processing example of a learning device and method.

FIG. 4 shows an example of a functional configuration of a computer.

FIG. 5 shows an example of a functional configuration of a transform device.

FIG. 6 shows an example of a processing procedure of a transform method.

FIG. 7 shows an example of mask processing.

FIG. 8 shows an example of mask processing.

FIG. 9 shows an example of mask processing.

FIG. 10 shows an example of a functional configuration of a transform device.

### DESCRIPTION OF EMBODIMENTS

Hereinafter, embodiments of the present invention will be described in detail. In the drawings, components having the same functions are denoted by the same reference numerals, and redundant description will be omitted.

### Learning Device and Method

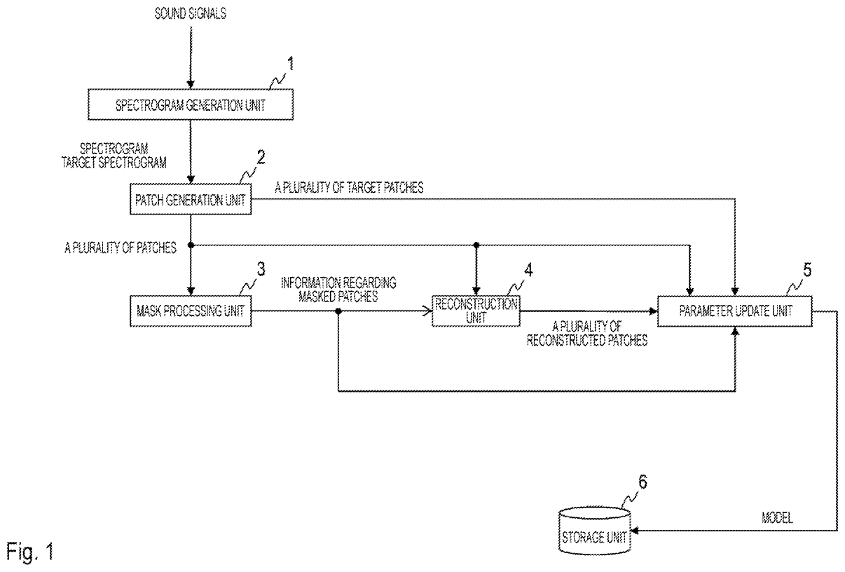

As shown in FIG. 1, a learning device includes, for example, a spectrogram generation unit 1, a patch generation unit 2, a mask processing unit 3, a reconstruction unit 4, a parameter update unit 5, and a storage unit 6.

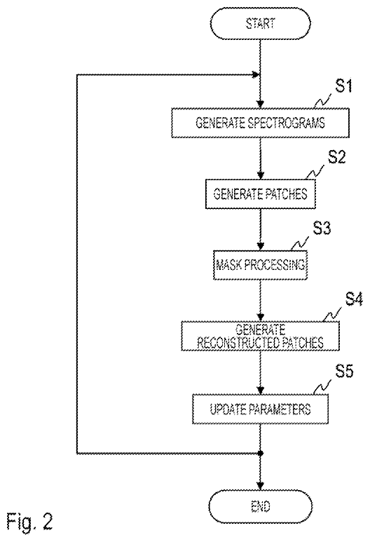

A learning method is implemented by, for example, each component of the learning device performing processing in step S1 to step S5 shown in FIG. 2.

### Spectrogram Generation Unit 1

A first sound signal and a second sound signal, such as an acoustic signal and an audio signal, are input to the spectrogram generation unit 1.

The spectrogram generation unit 1 generates a spectrogram from the input first sound signal and generates a target spectrogram from the input second sound signal (step S1).

The generated spectrogram and target spectrogram are output to the patch generation unit 2.

For example, when the number of spectrograms bin is denoted by B and the number of frames of the sound signal is denoted by F, the spectrogram and target spectrogram having a size of B×F are generated. The symbols B and F are predetermined positive integers. For example, B=80 and F=304 are satisfied. A time length of one frame is 10 ms.

### Patch Generation Unit 2

The spectrogram and target spectrogram generated by the spectrogram generation unit 1 are input to the patch generation unit 2.

The patch generation unit 2 divides the spectrogram to generate a plurality of patches and divides the target spectrogram to generate a plurality of target patches (step S2).

The plurality of generated patches is output to the mask processing unit 3, the reconstruction unit 4, and the parameter update unit 5.

The plurality of generated target patches is output to the parameter update unit 5.

For example, the patch generation unit 2 divides the spectrogram having the size of B×F into a size of b×f. The symbols b and f are predetermined positive integers. The symbol b may be a divisor of B, and the symbol f may be a divisor of F. For example, when B=80 and F=304 are satisfied, and b=16 and f=16 are satisfied, (80/16)×(304/16)=5×19=95 patches having a size of 16×16 are generated from the spectrogram having the size of 80×304. The same applies to the target spectrogram.

As described above, the patch generation unit 2 divides the spectrogram and the target spectrogram into grids, for example.

### Mask Processing Unit 3

The plurality of patches generated by the patch generation unit 2 is input to the mask processing unit 3.

The mask processing unit 3 selects some patches from among the plurality of patches as masked patches (step S3).

Information regarding the patches selected as the masked patches is output to the reconstruction unit 4 and the parameter update unit 5.

The mask processing unit 3 selects, for example, X % of the plurality of patches as the masked patches. The symbol X denotes a real number from 0 to 100. The symbol X is, for example, 75. The mask processing unit 3 may select 50% or more of the plurality of patches as the masked patches.

The mask processing unit 3 may randomly select patches or may select patches according to a predetermined pattern.

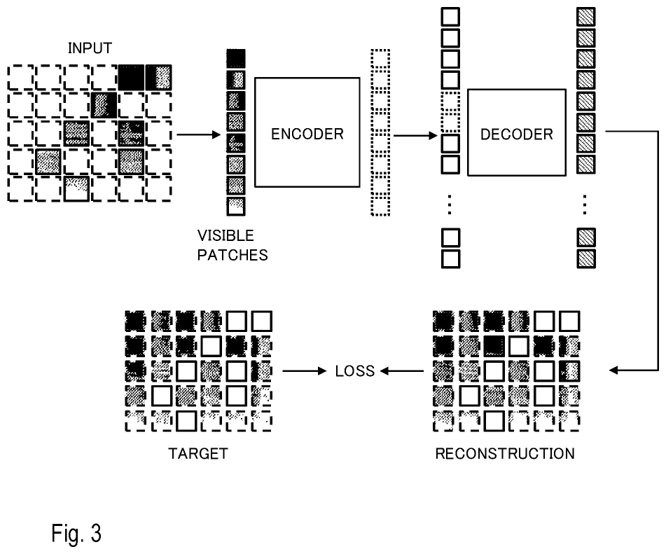

FIG. 3 shows an overview of a processing example of the learning device and method. As shown in INPUT in the example of FIG. 3, the spectrogram is divided into 5×6 patches. As shown in INPUT in the example of FIG. 3, patches indicated by broken lines are selected as the masked patches.

### Reconstruction Unit 4

The information regarding the masked patches selected by the mask processing unit 3 is input to the reconstruction unit 4. The plurality of patches generated by the patch generation unit 2 is also input to the reconstruction unit 4.

The reconstruction unit 4 obtains a plurality of reconstructed patches by reconstructing the plurality of patches by processing of an encoder and a decoder in a transformer serving as a deep learning model by using visible patches other than the masked patches among the plurality of patches and mask tokens corresponding to the masked patches (step S4).

The mask token is a vector. Each element of the mask token has, for example, a random real number as an initial value. As described later, the mask token may be updated by the parameter update unit 5. In this case, the reconstruction unit 4 uses the updated mask token.

The plurality of obtained reconstructed patches is output to the parameter update unit 5.

Hereinafter, examples 1 and 2 of the processing of the reconstruction unit 4 will be described.

### Example 1

An encoder processing unit 41 of the reconstruction unit 4 inputs the visible patches to the encoder in the transformer serving as the deep learning model to obtain an encoding result.

A decoder processing unit 42 of the reconstruction unit 4 inputs the encoding result and the mask tokens to the decoder to obtain a decoding result. As the decoding result, a plurality of reconstructed patches generated by reconstructing the plurality of patches is obtained.

In the example of FIG. 3, the visible patches indicated by the broken lines in INPUT other than the masked patches are input to the encoder, and an encoding result indicated by dotted lines is obtained. In the example of FIG. 3, a result obtained by adding the mask tokens corresponding to the masked patches to the encoding result is input to the decoder, and a decoding result indicated by a right-downward diagonal stripe pattern is obtained.

### Example 2

The encoder processing unit 41 of the reconstruction unit 4 inputs the visible patches and the mask tokens to the encoder in the transformer serving as the deep learning model to obtain an encoding result.

The decoder processing unit 42 of the reconstruction unit 4 inputs the encoding result to the decoder to obtain a decoding result. As the decoding result, a plurality of reconstructed patches generated by reconstructing the plurality of patches is obtained.

### Parameter Update Unit 5

The plurality of reconstructed patches obtained by the reconstruction unit 4 is input to the parameter update unit 5. The information regarding the masked patches selected by the mask processing unit 3 and the plurality of patches and the plurality of target patches generated by the patch generation unit 2 are also input to the parameter update unit 5.

The parameter update unit 5 updates a parameter of the encoder and a parameter of the decoder such that target patches corresponding to the masked patches among the plurality of target patches approach reconstructed patches corresponding to the masked patches among the plurality of reconstructed patches (step S5).

For example, the parameter update unit 5 updates the parameter of the encoder and the parameter of the decoder by a method such as backpropagation so as to reduce a magnitude of an error between the target patches corresponding to the masked patches among the plurality of target patches and the reconstructed patches corresponding to the masked patches among the plurality of reconstructed patches.

In the example of FIG. 3, the parameters are updated to reduce the magnitude of the error between the target patches corresponding to the masked patches indicated by broken lines in TARGET and the reconstructed patches corresponding to the masked patches indicated by broken lines in RECONSTRUCTION.

### Repetitive Processing

The processing in step S1 to step S5 is repeatedly performed. For example, the processing in steps S1 to S5 is performed on each of a plurality of different sound signals.

For example, the processing in steps S1 to S5 is repeatedly performed until the parameter of the encoder and the parameter of the decoder converge.

### Storage Unit 6

When the repetition is completed, a model serving as the encoder and the decoder determined based on the latest parameters updated by the parameter update unit 5 is stored in the storage unit 6.

### Modification Example of Learning Device and Method

The time length of the spectrogram may be longer than a predetermined time length. In other words, the number of frames of a sound signal input to the spectrogram generation unit 1 may be larger than the predetermined number of frames.

For example, the time length of the spectrogram may be equal to or more than four seconds. By increasing the time length of the spectrogram, performance of the model generated by the learning device and method is improved.

The size of the patch may be smaller than a predetermined size. For example, the size of the patch may be smaller than the size of 16×8, and the size of the patch may be smaller than the size of 16×4. Because a resolution is increased by reducing the size of the patch, the performance of the model generated by the learning device and method is further improved.

### Transform Device and Method

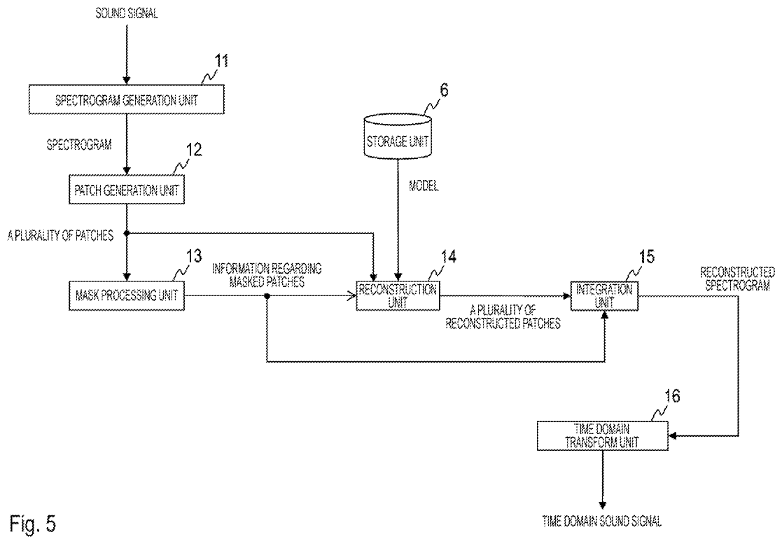

As shown in FIG. 5, a transform device includes, for example, a spectrogram generation unit 11, a patch generation unit 12, a mask processing unit 13, a reconstruction unit 14, an integration unit 15, a time domain transform unit 16, and the storage unit 6.

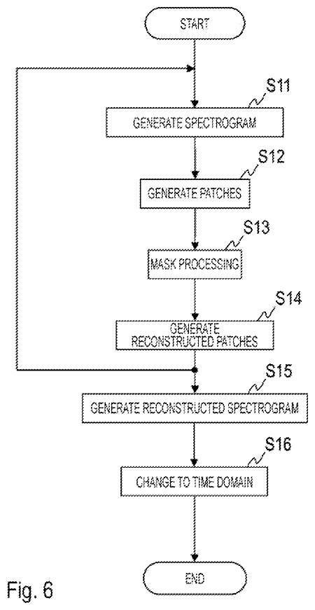

A transform method is implemented by, for example, each component of the transform device performing processing in step S11 to step S16 described below and shown in FIG. 6.

### Storage Unit 6

The storage unit 6 stores the model (the encoder and decoder in the transformer) learned by the learning device and method.

The spectrogram generation unit 11, the patch generation unit 12, the mask processing unit 13, and the reconstruction unit 14 described below perform processing similar to that of the spectrogram generation unit 1, the patch generation unit 2, the mask processing unit 3, and the reconstruction unit 4 in the learning device. Similar parts to those of the spectrogram generation unit 1, the patch generation unit 2, the mask processing unit 3, and the reconstruction unit 4 will not be described repeatedly.

### Spectrogram Generation Unit 11

A sound signal such as an acoustic signal or audio signal to be transformed is input to the spectrogram generation unit 11.

The spectrogram generation unit 11 generates a spectrogram (step S11).

The spectrogram is generated from the input sound signal.

The generated spectrogram is output to the patch generation unit 12.

### Patch Generation Unit 12

The spectrogram generated by the spectrogram generation unit 11 is input to the patch generation unit 12.

The patch generation unit 12 divides the spectrogram to generate a plurality of patches (step S12).

The plurality of generated patches is output to the mask processing unit 13 and the reconstruction unit 14.

### Mask Processing Unit 13

The plurality of patches generated by the patch generation unit 12 is input to the mask processing unit 13.

The mask processing unit 13 selects some patches from among the plurality of patches as masked patches (step S13).

Information regarding the patches selected as the masked patches is output to the reconstruction unit 14 and the integration unit 15.

### Reconstruction Unit 14

The information regarding the masked patches selected by the mask processing unit 13 is input to the reconstruction unit 14. The plurality of patches generated by the patch generation unit 12 is also input to the reconstruction unit 14.

The reconstruction unit 14 obtains a plurality of reconstructed patches by reconstructing the plurality of patches by processing of the encoder and the decoder read from the storage unit 6 by using visible patches other than some patches among the plurality of patches and mask tokens corresponding to the masked patches (step S14).

The plurality of obtained reconstructed patches is output to the integration unit 15.

### Repetitive Processing of Mask Processing Unit 13 and Reconstruction Unit 14

In the transform device and method, the processing of the mask processing unit 13 and the reconstruction unit 14 is repeatedly performed. In the repetitive processing, the mask processing unit 13 selects some or all of unselected patches from among the plurality of patches as the masked patches.

The processing of the mask processing unit 13 and the reconstruction unit 14 is performed until all of the plurality of patches are selected as the masked patches and reconstructed patches corresponding to all of the plurality of patches are obtained.

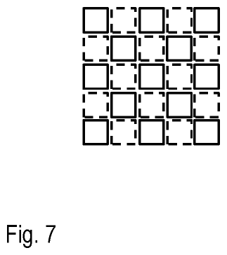

For example, assuming that the plurality of patches is arranged on a two-dimensional plane, the mask processing unit 13 may select masked patches in a checkered pattern. In this case, for example, in the first processing, the mask processing unit 13 selects patches indicated by solid lines in FIG. 7 as the masked patches. In the second processing, the mask processing unit 13 selects patches indicated by broken lines in FIG. 7 as the masked patches.

Further, assuming that the plurality of patches is arranged on the two-dimensional plane, the mask processing unit 13 may select every other masked patch in one coordinate axis direction of a coordinate system of the two-dimensional plane.

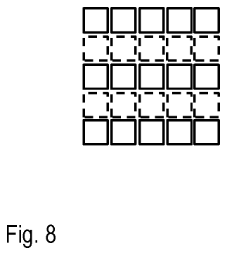

In this case, for example, in the first processing, the mask processing unit 13 selects patches indicated by solid lines in FIG. 8 as the masked patches. In the second processing, the mask processing unit 13 selects patches indicated by broken lines in FIG. 8 as the masked patches. In other words, the mask processing unit 13 may select every other masked patch in the vertical direction.

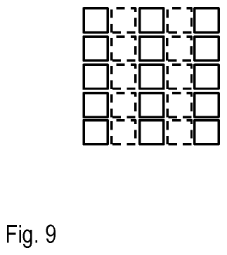

In this case, for example, in the first processing, the mask processing unit 13 may select patches indicated by solid lines in FIG. 9 as the masked patches, and, in the second processing, may select patches indicated by broken lines in FIG. 9 as the masked patches. In other words, the mask processing unit 13 may select every other masked patch in the lateral direction.

In the examples described with reference to FIGS. 7 to 9, all of the plurality of patches are selected as the masked patches in two times of processing, and the reconstructed patches corresponding to all of the plurality of patches are obtained.

### Integration Unit 15

The information regarding the masked patches selected by the mask processing unit 13 is input to the integration unit 15. The plurality of reconstructed patches obtained by the reconstruction unit 14 is also input to the integration unit 15.

The integration unit 15 performs processing of integrating the reconstructed patches corresponding to the masked patches among the plurality of reconstructed patches to generate a reconstructed spectrogram after the repetitive processing is completed (step S15).

The generated reconstructed spectrogram is output to a time domain transform unit 16.

### Time Domain Transform Unit 16

The reconstructed spectrogram generated by the integration unit 15 is input to the time domain transform unit 16.

The time domain transform unit 16 transforms the reconstructed spectrogram into a time domain sound signal (step S16).

### Transform Example 1

A model, which has been learned by giving a sound signal obtained by mixing a desired sound and noise as the first sound signal and giving only a desired sound as the second sound signal, is stored in the storage unit 6.

In this case, when the sound signal from which noise is to be removed is set as an input of the transform device and method, a sound signal having reduced noise is obtained by the time domain transform unit 16. In other words, in this case, the transform device and method can transform a sound signal having noise into a sound signal having reduced noise.

### Transform Example 2

A model, which has been learned by giving a low-resolution version of a desired sound as the first sound signal and giving a high-resolution version of the desired sound as the second sound signal, is stored in the storage unit 6.

In this case, when a low-resolution sound signal is set as an input of the transform device and method, a high-resolution sound signal can be obtained by the time domain transform unit 16. In other words, in this case, the transform device and method can transform a low-resolution sound signal into a high-resolution sound signal.

### Transform Example 3

A model, which has been learned by giving a sound signal of a desired transform source style as the first sound signal and giving a sound signal of a desired transform destination style as the second sound signal, is stored in the storage unit 6.

In this case, when the sound signal of the transform source style is set as an input of the transform device and method, the sound signal of the transform destination style can be obtained by the time domain transform unit 16. In other words, in this case, the transform device and method can transform the sound signal of the transform source style into the sound signal of the transform destination style.

Examples of (the sound signal of the transform source style and the sound signal of the transform destination style) include (voice of a speaker a and voice of a speaker b), (classical music and rock music), and (a sound of hitting a wooden door and a sound of hitting an iron door).

### Modification Example of Transform Device and Method

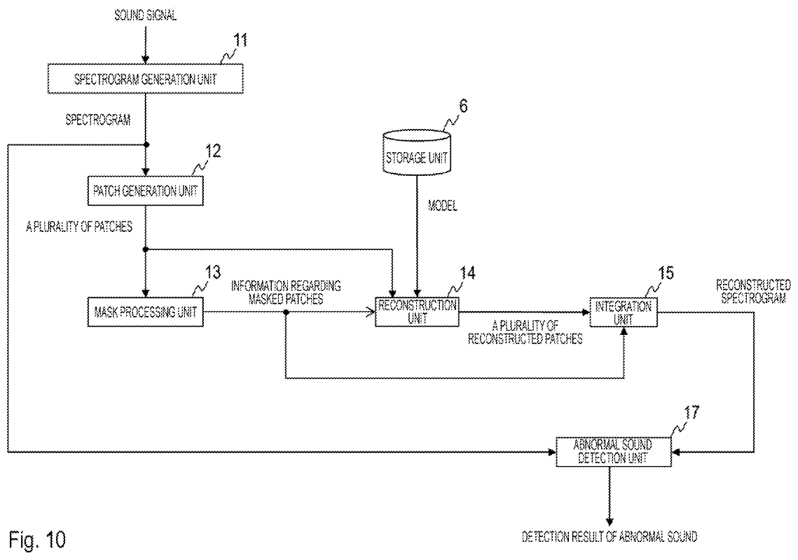

As shown in FIG. 10, the transform device includes an abnormal sound detection unit 17 instead of the time domain transform unit 16. The reconstructed spectrogram generated by the integration unit 15 and the spectrogram generated by the spectrogram generation unit 11 are input to the abnormal sound detection unit 17.

A model, which has been learned by giving normal sounds in an environment in which an abnormal sound is desired to be detected as the first sound signal and the second sound signal, is stored in the storage unit 6.

In this case, when an environmental sound of the environment in which an abnormal sound is desired to be detected is set as an input of the transform device and method, the integration unit 15 obtains a reconstructed spectrogram of the environmental sound of the environment in which an abnormal sound is desired to be detected.

The abnormal sound detection unit 17 calculates a magnitude of an error between the spectrogram and the reconstructed spectrogram, determines that the sound is abnormal in a case where the magnitude of the calculated error is larger than a predetermined threshold, and determines that the sound is normal in a case where the magnitude of the calculated error is not larger than the predetermined threshold.

For example, a model, which has been learned by giving normal operation sounds of a machine as the first sound signal and the second sound signal, is stored in the storage unit 6. Then, a sound generated by a broken machine is input to the transform device and method. In this case, there is no sound generated by a failure of the machine at the time of learning, and thus the magnitude of the error between the spectrogram and the reconstructed spectrogram increases.

Similarly, a model, which has been learned by giving normal sounds in a town as the first sound signal and the second sound signal, is stored in the storage unit 6. Then, a sound in the town including a scream is input to the transform device and method. In this case, there is no scream at the time of learning, and thus the magnitude of the error between the spectrogram and the reconstructed spectrogram increases.

By using the fact that the error increases when an abnormal sound is included as described above, an abnormality can be detected.

As in the example, the transform device and method may be used as an abnormal sound detection device and method.

### Modification Examples

While the embodiment of the present invention has been described above, specific configurations are not limited to the embodiment, and it is needless to say that appropriate design changes and the like are included in the present invention without departing from the gist of the present invention.

The various types of processing described in the embodiment may be performed not only in chronological order in accordance with the described order, but also in parallel or individually depending on the processing capability of a device that performs the processing or as necessary.

For example, data exchange between the components of the learning device and data exchange between the components of the transform device may be performed directly or via a storage unit (not illustrated).

### Program and Recording Medium

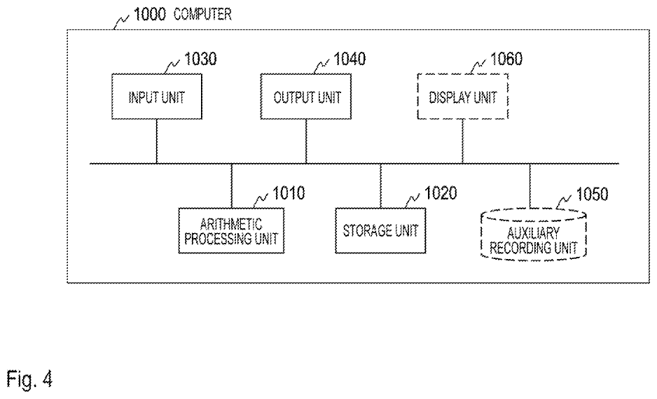

Processing of each unit of each device described above may be implemented by a computer, and, in this case, processing content of a function that each device should have is written by a program. By causing a storage unit 1020 of a computer 1000 in FIG. 4 to read the program and causing an arithmetic processing unit 1010, an input unit 1030, an output unit 1040, a display unit 1060, and the like to operate, various processing functions in each device described above are implemented on the computer.

The program in which the processing content is written can be recorded on a computer-readable recording medium. The computer-readable recording medium is, for example, a non-transitory recording medium and is specifically a magnetic recording device, an optical disc, or the like.

The program is distributed by, for example, selling, transferring, or renting a portable recording medium such as a DVD or a CD-ROM on which the program is recorded. Further, the program may be stored in a storage device of a server computer, and the program may be distributed by being transferred from the server computer to another computer via a network.

For example, the computer that executes the program first temporarily stores the program recorded in the portable recording medium or the program transferred from the server computer in an auxiliary recording unit 1050 serving as a non-transitory storage device of the computer. Then, at the time of performing processing, the computer reads the program stored in the auxiliary recording unit 1050 serving as the non-transitory storage device of the computer into the storage unit 1020 and performs processing according to the read program. As another embodiment of the program, the computer may directly read the program from the portable recording medium into the storage unit 1020 and perform processing according to the program, or, each time the program is transferred from the server computer to the computer, the computer may sequentially perform processing according to the received program. Further, the above processing may be performed by a so-called ASP (application service provider) service that implements a processing function only by issuing an instruction to execute the program and acquiring a result thereof, without transferring the program from the server computer to the computer. The program in the present embodiment includes information that is used for processing by an electronic computer and is equivalent to the program (e.g. data that is not a direct command to the computer but has a property that defines processing performed by the computer).

In the present embodiment, the present device is configured by executing a predetermined program on the computer. However, at least part of the processing content may be implemented by hardware. For example, the spectrogram generation unit 1, the patch generation unit 2, the mask processing unit 3, the reconstruction unit 4, the parameter update unit 5, the spectrogram generation unit 11, the patch generation unit 12, the mask processing unit 13, the reconstruction unit 14, the integration unit 15, and the time domain transform unit 16 may be configured by a processing circuit.

In addition, it is needless to say that modifications can be appropriately made without departing from the gist of the present invention.

1. A learning device comprising:
spectrogram generation circuitry that generates a spectrogram from an input first sound signal and generates a target spectrogram from an input second sound signal;
patch generation circuitry that divides the generated spectrogram to generate a plurality of patches and divides the generated target spectrogram to generate a plurality of target patches;
mask processing circuitry that selects some patches from among the plurality of patches as masked patches;
reconstruction circuitry that obtains a plurality of reconstructed patches by reconstructing the plurality of patches by processing of an encoder and a decoder in a transformer serving as a deep learning model by using visible patches other than the some patches among the plurality of patches and mask tokens corresponding to the masked patches; and
parameter update circuitry that updates a parameter of the encoder and a parameter of the decoder such that target patches corresponding to the masked patches among the plurality of target patches approach reconstructed patches corresponding to the masked patches among the plurality of reconstructed patches.

2. A transform device comprising:
a storage that stores the encoder and the decoder learned by the learning device according to claim 1;
spectrogram generation circuitry that generates a spectrogram from an input sound signal;
patch generation circuitry that divides the generated spectrogram to generate a plurality of patches;
mask processing circuitry that selects some patches from among the plurality of patches as masked patches; and
reconstruction circuitry that obtains a plurality of reconstructed patches by reconstructing the plurality of patches by processing of the encoder and the decoder read from the storage by using visible patches other than the some patches among the plurality of patches and mask tokens corresponding to the masked patches.

3. The transform device according to claim 2, wherein:
processing of the mask processing circuitry and the reconstruction circuitry is repeatedly performed;
in the repetitive processing, the mask processing circuitry selects some or all of unselected patches from among the plurality of patches as the masked patches; and
the transform device further includes integration circuitry that performs processing of integrating reconstructed patches corresponding to the masked patches among the plurality of reconstructed patches to generate a reconstructed spectrogram after the repetitive processing is completed, and time domain transform circuitry that transforms the reconstructed spectrogram into a time domain sound signal.

4. The transform device according to claim 3, wherein:
the plurality of patches is arranged on a two-dimensional plane; and
the mask processing circuitry selects masked patches in a checkered pattern.

5. The transform device according to claim 3, wherein:
the plurality of patches is arranged on a two-dimensional plane; and
the mask processing circuitry selects every other masked patch in one coordinate axis direction of a coordinate system of the two-dimensional plane.

6. A learning method comprising:
a spectrogram generation step of causing spectrogram generation circuitry to generate a spectrogram from an input first sound signal and generate a target spectrogram from an input second sound signal;
a patch generation step of causing patch generation circuitry to divide the generated spectrogram to generate a plurality of patches and divide the generated target spectrogram to generate a plurality of target patches;
a mask processing step of causing mask processing circuitry to select some patches from among the plurality of patches as masked patches;
a reconstruction step of causing reconstruction circuitry to obtain a plurality of reconstructed patches by reconstructing the plurality of patches by processing of an encoder and a decoder in a transformer serving as a deep learning model by using visible patches other than the some patches among the plurality of patches and mask tokens corresponding to the masked patches; and
a parameter update step of causing parameter update circuitry to update a parameter of the encoder and a parameter of the decoder such that target patches corresponding to the masked patches among the plurality of target patches approach reconstructed patches corresponding to the masked patches among the plurality of reconstructed patches.

7. A transform method comprising:
a spectrogram generation step of causing spectrogram generation circuitry to generate a spectrogram from an input sound signal;
a patch generation step of causing patch generation circuitry to divide the generated spectrogram to generate a plurality of patches;
a mask processing step of causing mask processing circuitry to select some patches from among the plurality of patches as masked patches; and
a reconstruction step of causing reconstruction circuitry to obtain a plurality of reconstructed patches by reconstructing the plurality of patches by processing of an encoder and a decoder read from a storage unit storing the encoder and the decoder learned by the learning method according to claim 6 by using visible patches other than the some patches among the plurality of patches and mask tokens corresponding to the masked patches.

8. A non-transitory computer readable medium that stores a program for causing a computer to perform each step of the learning method according to claim 6.

9. A non-transitory computer readable medium that stores a program for causing a computer to perform each step of the transform method according to claim 7.
